(19) United States
(12) Patent Application Publication
(10) Pub. No.: US 2012/0098370 A1
(43) Pub. Date: Apr. 26, 2012

(54) STABILIZATION OF FLYWHEELS

(75) Inventors: John Michael Pinneo, Portola Valley, CA (US); Jonathan Forrest Garber, Hillsborough, CA (US)

(73) Assignee: SPINLECTRIX INC., Hillsborough, CA (US)

(21) Appl. No.: 13/280,232

(22) Filed: Oct. 24, 2011

Related U.S. Application Data
(60) Provisional application No. 61/406,103, filed on Oct. 22, 2010.
(60) Provisional application No. 61/406,102, filed on Oct. 22, 2010.
(60) Provisional application No. 61/406,105, filed on Oct. 22, 2010.
(60) Provisional application No. 61/406,099, filed on Oct. 22, 2010.
(60) Provisional application No. 61/406,104, filed on Oct. 22, 2010.
(60) Provisional application No. 61/406,107, filed on Oct. 22, 2010.

(51) Int. Cl. H02K 7/09

(52) U.S. Cl. 310/90.5

(57) ABSTRACT

This invention improves the operation of flywheels by allowing rotation about an inertial axis without the generation of imbalance forces that arise from the use of bearings to support the rotating components of the flywheel. The system uses periodic positional corrections to the rotating components of the flywheel so as to ensure that the system rotates within a predetermined boundary without continuously confining the rotating components to rotate about their geometric axis.

### CROSS-REFERENCE TO RELATED APPLICATIONS

This application claims priority to U.S. Provisional Application 61/406,103 filed Oct. 22, 2010, entitled “Methods for Stabilization of Flywheels,” U.S. Provisional Application 61/406,102 filed Oct. 22, 2010, entitled “Method of Stabilization of Rotating Machinery,” U.S. Provisional Application 61/406,105 filed Oct. 22, 2010, entitled “Permanent Magnets for Flywheels,” U.S. Provisional Application 61/406,099 filed Oct. 22, 2010, entitled “Flywheel Structures,” U.S. Provisional Application 61/406,104 filed Oct. 22, 2010, entitled “Kinetic Energy Storage Rotor Design,” and U.S. Provisional Application 61/406,107 filed Oct. 22, 2010, entitled “Concrete Vacuum Enclosures for Energy Storage Flywheels.” Each of these references are incorporated herein by reference in their entirety.

### BACKGROUND OF THE INVENTION

1. The Field of the Invention

The present invention relates to flywheels. More particularly, the present invention relates to improved systems and methods for maintaining stability in flywheels.

2. The Relevant Technology

Flywheels, particularly those used for energy storage, comprise a class of spinning bodies that consist of a rotating portion (a rotor) which is supported in proximity to a nonrotating portion (a stator). Energy is stored in the rotor as kinetic energy according to the relationship E=Iω²/2, where E is energy (Joules), I is the rotor's moment of inertia (kg-m²) and ω is the rotor's rotation rate (radians/second). It is apparent from this relationship that increasing the rotation rate of a flywheel rotor will increase its stored kinetic energy in proportion to the square of the rotation rate increase.

Flywheel rotors are commonly fixed in position with respect to their adjacent nonrotating components using bearings, a class of component whose use with rotating machinery was first described by Hero of Alexandria in the first century A.D. Bearings comprise a wide variety of configurations and modes of operation. For example, various bearings are known which employ solid materials (as in sleeve or rolling element bearings), fluids (as in gas or liquid film bearings), or force fields (as in magnetic or electrostatic bearings). Bearings may further be classified according to whether they are passive, wherein their characteristics derive from their basic mechanical configuration and properties, which may include damping, compliance, or other effects achievable by passive means, or active, wherein their action is modulated by active controls, often incorporating sensing, computation, and effector functions.

The fundamental action of bearings is to constrain rotation of a spinning body to a preferred geometric axis of rotation as determined by the spinning body's mass distribution. The preferred geometric axis of rotation may or may not coincide with the body's inherent inertial axis of rotation Non-equivalence of these two different types of rotational axes gives rise to imbalance forces that are well known as limiters of rotation speed and lifetime of rotating machinery. Examples of non-equivalence between a rotor's inertial rotational axis and its bearing-defined geometric rotational axis may be seen in FIGS. 1A-D.

More particularly, as shown in FIGS. 1A-1D, a rotating body 2 rotates in free space. The rotating body 2 has a shaft 4 that is substantially collinear with a geometric axis of rotation 3 which is defined by bearings 5. In FIG. 1A, the rotating body 2 has an inertial axis of rotation 6, which lies parallel to the Z-axis of the coordinate system 1. As described above, ideally the geometric axis of rotation 3 is identical to the inertial axis of rotation 6, but as shown in FIG. 1A, the inertial axis of rotation 6 is often slightly displaced form the geometric axis of rotation 3. FIG. 1B illustrates a rotating body 2 which has an inertial axis of rotation 6 which lies parallel to the Z-axis, but which is displaced in the negative direction along the X-axis from the geometric axis 3 of rotation. FIG. 1C illustrates a third alternative, where the rotating body 2 has an inertial axis of rotation 6 which is not parallel to the Z-axis and which is displaced from the geometric axis of rotation 3 by an angular rotation about the Y-axis. Finally, FIG. 1D illustrates yet another example where the rotating body 2 has an inertial axis of rotation 6 which is not parallel to the Z-axis and which is displaced from the geometric axis of rotation 3 by an angular rotation about the Y-axis, a negative direction of the X-axis, and a negative axis of the Z-axis.

With particular regard to the present invention, imbalance forces produced by the combination of disparity between geometric and rotational axes with the use of bearings to support flywheel rotors may limit the upper speed of rotation of a rotor, may result in unstable operation below a certain speed of rotation particular to a given rotor, can damage and/or reduce the lifetime of rotor support bearings, and can induce adverse vibrations in the flywheel rotor and/or in nonrotating components of the flywheel or its surrounding structures.

Bearings may be characterized by their “stiffness,” or the degree to which they resist a rotor's tendency to depart from the geometric rotational axis determined by its bearings. For a given deviation from a geometric rotational axis, a stiffer bearing imposes a larger restoring force than a softer bearing. In this respect, a bearing acts as a spring, generating a restoring force according to Hooke's Law, F=−kx, where F is a force (N), k is a spring constant (Nm⁻¹) and x is the displacement of the spring from its equilibrium position. A mechanical bearing rigidly mounted comprises a spring with k determined by the Young's modulus of the bearing material.

In summary, the use of bearings to support spinning bodies generates forces that:
act on the spinning body, its bearings, and the bearings' interface with the nonrotating environment;
vary linearly in magnitude with the displacement between a body's inertial rotational axis and its geometric rotational axis;
vary as the square of the body's rotation rate;
are fundamentally synchronized to the body's rotation, with a phase displacement that arises from the well-known effects of gyroscopic precession inherent to all spinning bodies;
arise as a result of a body rotating while being constrained to a geometric rotational axis.

As described above, the use of bearings inevitably results in imbalance forces being created, which can limit the rotational speed of the rotor and effect the longevity and effectiveness of the system. Thus, there is a need for a more effective and efficient method for stabilizing flywheels.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for stably operating a flywheel wheel. More specifically, in contrast to the systems described above, which constrain the rotation of the rotor of the flywheel to its geometric axis, the embodiments described herein enable the rotor of the flywheel to spin about its inertial rotational axis.

A flywheel rotor spinning without constraint, as it would momentarily do during free fall if its bearings and other supports were suddenly removed, experiences only centrifugal forces arising from rotation as it spins about its inertial rotational axis. Unfortunately, however, although the rotor operating in such conditions is not subject to imbalance forces, the benefits of such a configuration are short lived due to the eventual and inevitable collision of the flywheel with its nonrotating environment.

In order to overcome this problem, the embodiments described herein enable a flywheel rotor to rotate substantially about its inertial axis for a useful duration. As described more fully below, such systems mitigate or avoid the many deleterious effects of bearings and their associated costly rotor balancing requirements.

A first aspect of the invention is a flywheel rotor assembly comprising a rotor assembly having an inner rotor component coupled to an outer rotor component by a mechanical connection, wherein the rotor assembly is configured to rotate about an inertial axis of rotation, a means for rotating the rotor assembly about its inertial axis, a means for supporting the rotor assembly while it rotates around its inertial axis without confining the rotor assembly to rotate around a defined geometric axis of rotation of the rotor assembly, a means for detecting when the rotor assembly rotates outside a first boundary comprising a natural boundary that the rotating assembly rotates in when rotating about its inertial axis first boundary and supported by the means for supporting the rotor assembly, and a means for performing positional correction on the rotor assembly when it is determined that the rotor assembly rotates outside the first boundary so as to cause the rotor assembly to rotate to rotate inside the first boundary, wherein the positional correction does not confine the rotor assembly to rotate around its defined geometric axis of rotation.

A second aspect of the invention is a flywheel rotor assembly comprising a rotor assembly having an inner rotor component coupled to an outer rotor component by a mechanical connection, wherein the rotor assembly is configured to rotate about an inertial axis of rotation, a means for rotating the rotor assembly, a first means for supporting the rotor assembly which confines the rotor assembly to rotate around a geometric axis of the rotor assembly, a means for causing the first means for supporting the rotor assembly to disengage from the rotor assembly, a second means for supporting the rotor assembly while it rotates about an inertial axis of the rotating assembly without confining the rotor assembly to rotate around a defined geometric axis of rotation of the rotor assembly, a means for detecting when the rotor assembly rotates outside the first boundary, and a means for performing positional correction on the rotor assembly when it is determined that the rotor assembly rotates outside the first boundary so as to cause the rotor assembly to rotate to rotate inside the first boundary, wherein the positional correction does not confine the rotor assembly to rotate around its defined geometric axis of rotation.

A third aspect of the invention is a method for stabilizing flywheel rotation. The method includes a rotor assembly having an inner rotor component coupled to an outer rotor component by a mechanical connection to rotate about an inertial axis of rotation of the rotor assembly, said rotor assembly having a displacement between its inertial axis of rotation and a defined geometric axis of rotation of the rotor assembly, supporting the rotor assembly while it rotates around its inertial axis without confining the rotor assembly to rotate around the defined geometric axis of rotation, detecting when the rotor assembly rotates outside a first boundary comprising a natural boundary that the rotating assembly rotates in when rotating about its inertial axis first boundary and being supported, performing positional correction on the rotor assembly when it is determined that the rotor assembly rotates outside the first boundary so as to cause the rotor assembly to rotate to rotate inside the first boundary, wherein the positional correction does not confine the rotor assembly to rotate around its defined geometric axis of rotation.

As may be understood by one of ordinary skill in the art, embodiments described herein provide, among other things, a combination of means of: (1) suspending a flywheel rotor such that rotation substantially about its inertial axis is enabled, and; (2) adding energy to, and withdrawing energy from the rotor while accommodating its rotation substantially about its inertial axis, and; (3) sensing and controlling a flywheel rotor's position in space such that it remains free to rotate substantially about its inertial axis, yet is not free to undergo undesirable contact with its surroundings.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-1D are cross-sectional side views which illustrate a rotating body rotating in free space which have displaced inertial axes of rotation and geometric axes of rotation;

FIG. 2 is a cross section of a flywheel according to one embodiment of the invention;

FIG. 3 is a cross section of the flywheel according to one embodiment of the invention;

FIG. 4 is a cross section which illustrates a means for detecting the position of the flywheel according to one embodiment of the invention;

FIG. 5 is a cross section of a means for temporarily supporting the flywheel according to one embodiment of the invention;

FIG. 6 is a cross section of a means for positioning the flywheel according to one embodiment of the invention; and

FIG. 7 is a block diagram illustrating a method for rotating a flywheel according to an embodiment of the invention.

### DETAILED DESCRIPTION OF THE PREFERRED EMBODIMENTS

Embodiments of the invention relate to improved systems and methods for providing stabilization of flywheels.

In a preferred embodiment of this invention, a flywheel rotor is supported by means that confine the spinning rotor to a permissible range of locations, but that do not confine the rotor to a geometric axis of rotation.

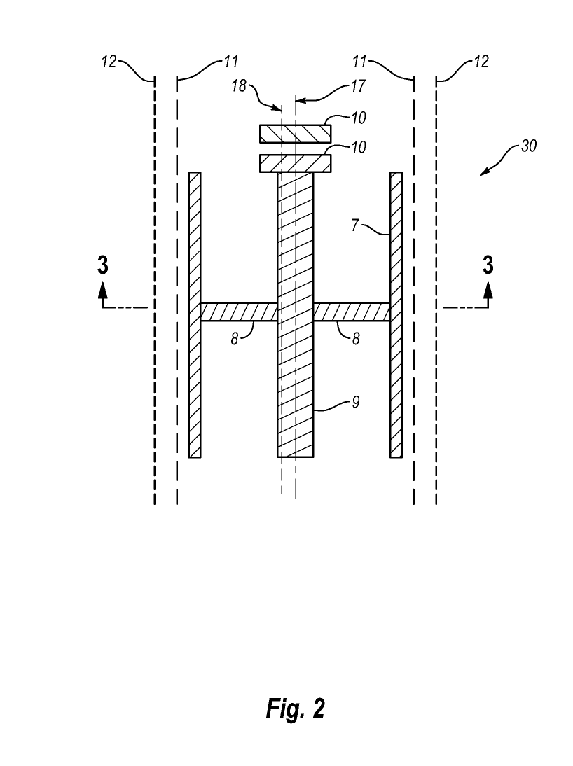

FIG. 2 depicts a generalized schematic sectional view of a flywheel rotor assembly 30 which may be used in association with the invention. The flywheel rotor assembly 30 is comprised of an outer rotor component 7 coupled by mechanical connection means 8 to inner rotor component 9. The rotor assembly is suspended against the force of gravity by means of suspension 10. Broken lines 11 depict the natural outer boundary along the X-axis according to coordinate system 1 that the flywheel rotor assembly 30 will rotate within when it is rotating about its natural inertial rotational axis, when the rotation is observed by a stationary observer at the origin of the X- and Z-axes, and viewing the flywheel rotor assembly 30 along the Y-axis in the positive direction. Dashed lines 12 depict the predetermined permitted limits of the area within which the flywheel rotor assembly 30 is permitted to rotate along the X-axis before positional controls are applied to the flywheel rotor assembly 30.

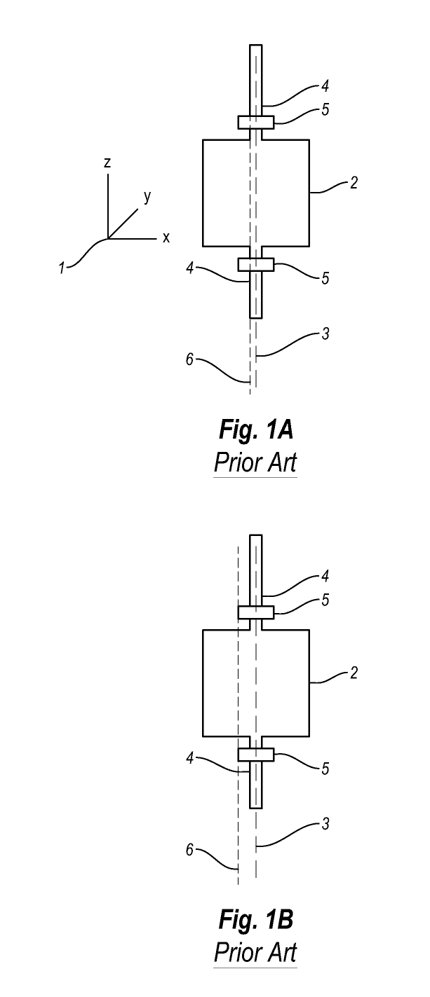

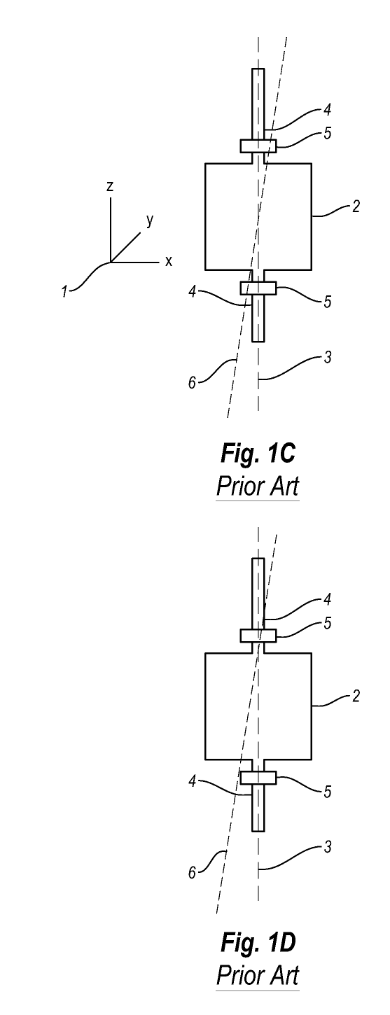

With respect to FIG. 2, the flywheel rotor assembly 30 exhibits a natural inertial axis of rotation 18 that differs from its geometric center 17. In this example, similar to the situation shown in FIG. 1A and 1B, the flywheel rotor assembly 30 has an inertial axis of rotation 18, which lies parallel to the Z-axis of the coordinate system 1 and which is displaced in the negative direction along the X-axis from the geometric axis of rotation 17. As may be understood by one of ordinary skill in the art, this example is illustrative only and any number of conditions may occur wherein the natural inertial axis of rotation 18 differs from the geometric center 17 of the flywheel rotor assembly 30, such as according to one or more of the conditions depicted in FIGS. 1A-D.

Because the natural inertial axis of rotation 18 differs from the geometric center 17, the flywheel rotor assembly 30 exhibits a rotational eccentricity with respect to its excursion along the X- and Y-axes of coordinate system 1. As described above, the natural outer boundary along the X-axis that the rotor assembly 11 will rotate about when it is rotating about its natural inertial axis 18. As described above, the natural inertial axis 18 is determined by the specific geometry and mass distribution of the flywheel rotor assembly.

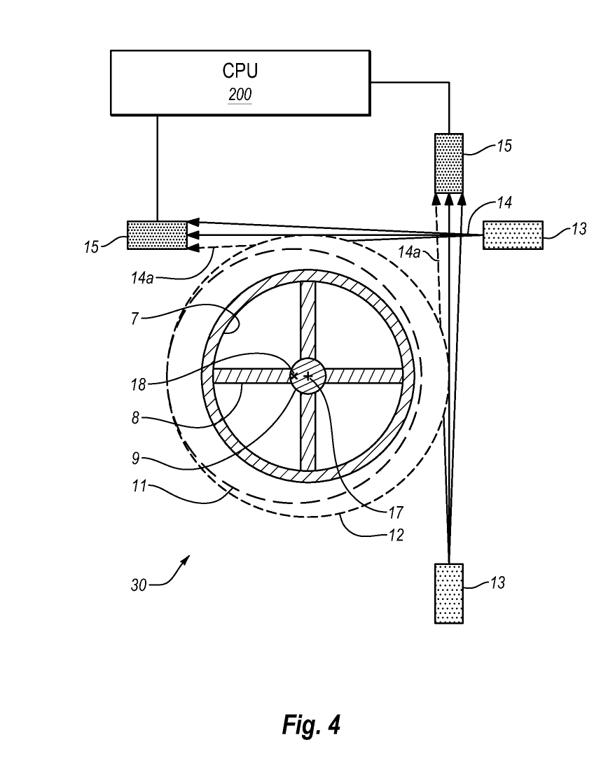

In comparison to the natural outer boundary 11 that the flywheel rotor assembly 30 rotates about when rotating about its natural inertial axis, element 12 defines a predetermined and arbitrarily established boundary in the X- and Y-axes within which the outer rotor component 7 is allowed to freely rotate without any constraint or corrections in its position. As described more fully below, when the outer rotor component 7 moves beyond the limits of boundary 12 in either or both the X- and Y-axes, sensors (described more fully below with reference to FIG. 4) detect this condition and generate information that is transmitted to means of control (not depicted in this figure), as described more fully below.

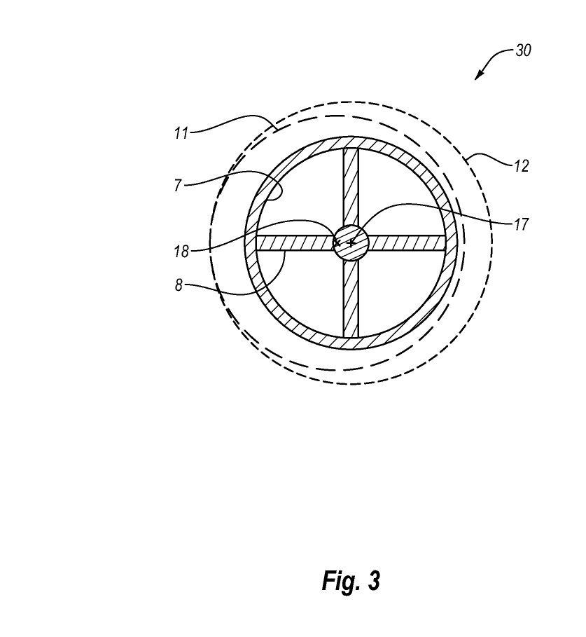

FIG. 3 is a cross-sectional view of the configuration illustrated in FIG. 2 along the line A-A. In this Figure, the means of suspension 10 for suspending the flywheel rotor assembly 30 is omitted for clarity. As described above, the flywheel rotor assembly 30 exhibits a natural inertial axis of rotation 18 that differs from its geometric center 17. As described above the flywheel rotor assembly 30 exhibits a rotational eccentricity with respect to its excursion along the X- and Y-axes of coordinate system 1. As shown in FIG. 3, boundary 11 is determined by, and limited to, the particular relationship between the rotor's inertial axis and its geometry. In this instance, the boundary 11 comprises a circle which has a center which is located at the rotor's inertial axis 18. Those of ordinary skill in the art will appreciate that various boundaries may be established with varying shapes and sizes, based on the unique inertial axis 18 of the flywheel rotor assembly 30.

As described above, boundary 12 defines a predetermined limit along the X- and Y-axes within which the outer rotor component 7 of the flywheel rotor assembly 30 is allowed to freely move without restraint. When the outer rotor component 7 moves beyond the limits of boundary 12 in either or both the X- and Y-axes, sensors (not depicted in this figure) detect this condition and generate information that is transmitted to means of control (not depicted in this figure), which then corrects the position of the flywheel rotor assembly 30 as described more fully below.

With respect to FIG. 4, a flywheel rotor assembly 30 is shown as depicted in FIGS. 2 and 3, but with the addition of sensor means comprising light emitters 13 and photodetectors 15 disposed substantially parallel to the X- and Y-axes. These sensor means 13 and 15 are disposed so that no modulation of their signals occurs so long as the flywheel rotor assembly 30 spins within the boundary 12. In this particular embodiment, if the flywheel rotor assembly 30 departs boundary 12 along either or both of the X- or Y-axes, light beams 14 will be occluded, a portion 14a of said beam being blocked off from photodetectors 15, thereby changing the photodetectors' signals and providing an indication that the flywheel rotor assembly 30 has exceeded its permitted geometric limits of operation.

Each sensor assembly consists of a diode laser 13 that emits a beam of light 14 and a photodetector 15 disposed as described above. Suitable lasers 13 include a wide range of electrically-driven diode lasers emitting light in the visible spectrum between 635 nm and 650 nm, such as the model LLP6501FS available from Lasermate Group, Inc., of Pomona, Calif. Suitable photosensitive detectors 15 include silicon photodiodes such as those available from Hamamatsu Corporation with offices in Bridgewater, New Jersey. By means well-known in the art, the position of the flywheel rotor assembly 30 in the X- and Y-axes may be computed at a computer including a processing unit (CPU) 200 from position sensor data and used to derive position control information.

As shown in FIG. 4, the CPU 200 is connected to both the photodetectors 15. As may be understood by those of skill in the art, the CPU 200 may be connected to various other components, including, but not limited to the light emitters 13. As described more fully below, the CPU 200 is also configured to be connected to the position connecting means as described more fully below.

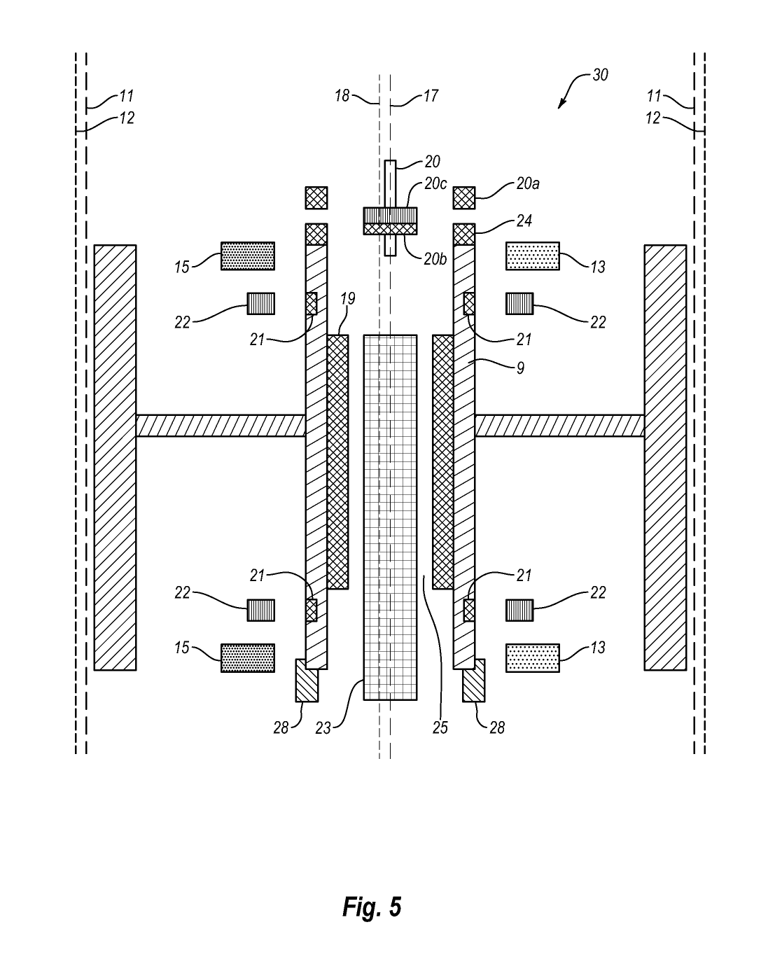

FIG. 5 is a sectional schematic view of the rotator assembly 5 in greater detail. This configuration includes a stationary component comprising a stator assembly 23 that incorporates means of electrically generating magnetic fields and/or of generating electrical currents in response to time-varying magnetic fields that may be incident upon it. The outermost surface of stator assembly 23 is separated from the innermost surface of magnet array 19 by a gap 25. Means of sensing the rotor's position on the Z-axis and of energizing optional electromagnet 20c are omitted for clarity. Touchdown bearings 28 provide means of supporting the flywheel rotor assembly 30 when it is desired to disengage the means of suspension 10 as is common practice when a suspended flywheel is not rotating, as prior to startup or after shutdown.

With respect to FIG. 5, a flywheel rotor assembly 30 is depicted in schematic sectional view under static conditions in which a geometric central axis 17 is located at the geometric center of stator assembly 23 while inertial axis of rotation 18 lies displaced along the X-axis from the geometric center of stator 23 assembly. Flywheel rotor assembly 30 is suspended against the force of gravity by the attractive interaction of ring magnets 20a and 24, the former being fixed at least in the Z-axis to the flywheel rotor's nonrotating surroundings and the latter being fixed to inner rotor component 9. The interaction of these two ring magnets 20a and 24 is modified by ring magnet 20b and electromagnet 20c such that the flywheel rotor assembly 30 is located at a desirable position along the Z-axis substantially without the production of forces having projections into either the X- or Y-axes, according to methods well-known in the art of active magnetic positioning.

In a preferred embodiment, ring magnets 20a and 24 have inner radii of 2.5 inches, outer radii of 3 inches, and a section thickness of 0.5 inches. Their magnetization vectors lie along the section thickness, with magnetic poles therefore being on the planar faces of the rings. As employed in this invention, they are disposed with magnetic poles oriented to provide an attractive force between them, thereby supporting the outer rotor component 7 to which ring magnet 24 is affixed. In a preferable embodiment, ring magnets 20a and 24 are fabricated from industry grade 42 or higher rare earth magnet materials according to art well known in the field. Other operable magnetic materials are known and this invention is not limited thereby.

It is within the contemplation of this invention that either of the ring magnets 20a and 24 may be replaced by a ferromagnetic body made from iron or other material having similar magnetic properties so that an attractive force may be developed whereby to support flywheel rotor assembly 30 and its affixed components. It is further contemplated within the scope of this invention that the means of support of flywheel rotor assembly 30 may comprise magnets in repulsion and disposed underneath the rotor to provide support, or in combination with means of support disposed atop the rotor as previously described.

Disc magnet 20b is preferably made of industry Grade 42 or higher rare earth magnet materials according to art well known in the field and has an outer radius of 0.5 inch, an inner radius of 0.125 inches, and a section thickness of 0.5 inches. Other operable magnetic materials are known and this invention is not limited thereby. Optional electromagnet 20c consists of up to 500 turns of insulated magnet wire as is known to the art and may be disposed adjacent to, or within suitable proximity of, magnet 20b, and is energized so as to modulate the interactions of magnets 20a, 20b, and 24 in such a way that flywheel rotor assembly 30 is supported against the pull of gravity in a desired region along the Z-axis of coordinate set 1 and such that there is little or substantially no change in force components projected onto the X- and/or Y-axes for displacements of the outer rotor component 7 along those axes such that the displacements along either axis do not substantially exceed the allowable spin volume boundary 12 along either axis. In a preferred embodiment, magnet 20b is adjusted with respect to magnets 20a and 24 so as to provide a minimal stabilizing force with respect to flywheel rotor assembly's 30 position along the Z-axis.

In another preferred embodiment, magnet 20b is adjusted with respect to magnets 20a and 24 so as to provide a minimally destabilizing force with respect to flywheel rotor assembly's 30 position along the Z-axis, and electromagnet 20c is energized so as to control the flywheel rotor's location along the Z-axis. In another preferred embodiment, electromagnet 20c is employed only to levitate the flywheel rotor assembly 30 from its touchdown bearings 28 as part of a startup sequence, and/or to cause the flywheel rotor assembly 30 to descend from its operating position onto its touchdown bearings 28 as part of a shutdown sequence.

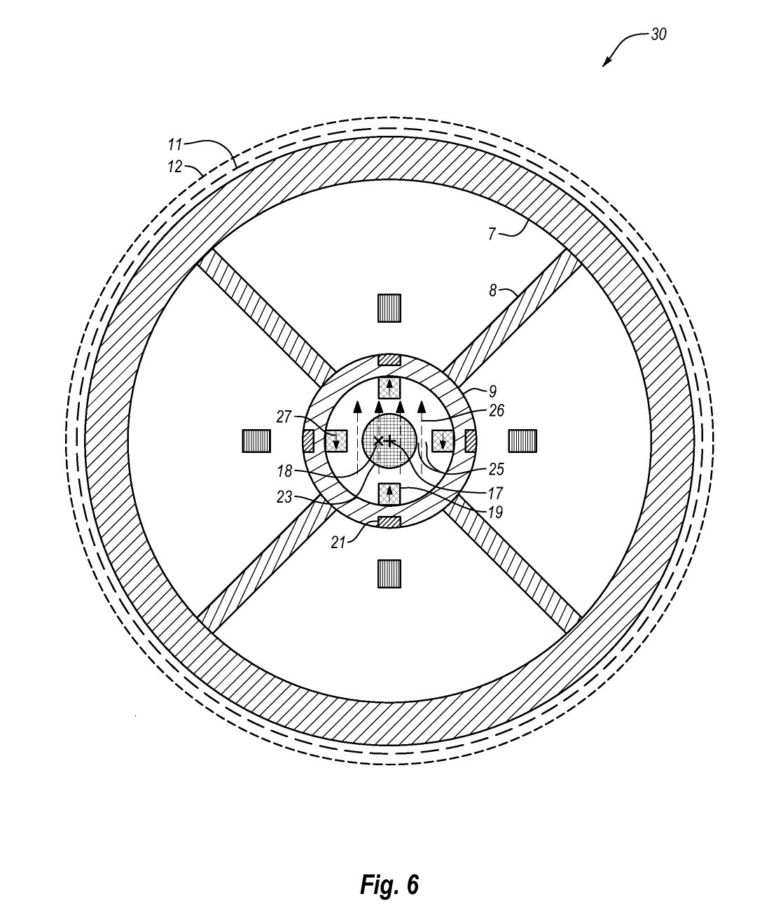

Referring now to FIGS. 5 and 6, magnet array 19 is comprised of four permanent magnets disposed around the circumference of inner rotor component 9 at 90 degree angular intervals with their longest dimension aligned along the Z-axis of coordinate system 1. Magnetization vectors 27 indicate the direction of the magnets' north poles. Magnets comprising array 19 may be formed of permanent magnetic materials, including the well-known rare earth magnetic materials, as well as magnetic ceramics or ferrites, ALNICO, or other permanent magnetic materials. In a preferred embodiment, the magnets comprising magnet array 19 are composed of industry Grade 42 or stronger neodymium/iron/boron material and have dimensions of one inch×one inch×eight inches along the Z-axis. In another preferred embodiment, the magnets comprising magnet array 19 are composed of industry Grade C8 ceramic or ferrite magnetic material. Individual magnets in magnet array 19 have dimensions of 1 inch×1 inch×8 inches and have their North-pointing magnetization vector 27 lying across either of the two “short” dimensions.

Although the configuration shown in FIGS. 5 and 6 of the magnet array 19 consists of four magnets disposed at 90 degree intervals about the stator 23, those of skill in the art will appreciate that any number of magnets may be used in the magnet array 11 and that those magnets may be arranged in any number of configurations without departing from the scope of the following claims.

Again referring to FIGS. 5 and 6, flywheel rotor assembly 30 has a weight of approximately 200 pounds, which includes the weights of its affixed components. The outer radius of outer rotor component 7 is approximately 18 inches, its inner radius is approximately 16 inches, and its height is approximately 20 inches Inner rotor component 9 has an outer radius of 3 inches, an inner radius of 2.5 inches, and a height of approximately 20 inches. Mechanical connection means 8 has a length adequate to connect across the gap between the inner surface of outer rotor component 7 and the outer surface of inner rotor component 9 with an additional length needed for mechanical connections to said components, in this case approximately 14 inches. The outer rotor component 7 is comprised principally of a substantially hoop-wound fiber as is known to the art of flywheels, said fiber being selected from at least one of the classes of materials including metals, plastics, glasses, and ceramics, including fiber-reinforced matrix material, where the fibers and/or are selected from at least one of the classes of materials including metals, plastics, glasses, and ceramics. An enabling fiber material in this embodiment is a high strength aramid fiber such as Kevlar, available from E.I. du Pont de Nemours and Company of Wilmington, Del.

The boundary 11 as illustrated by the circular broken line represented the boundary of eccentric rotation determined by, and limited to, the particular relationship between the rotor's inertial axis and its geometry. Boundary 12 as illustrated by the circular broken line represents the permitted limits of excursion of the outer rotor component 7 projected along the X- and Y- axes. Gap 25 is at least equal to, or greater than, the diameter of circle 12 from which is subtracted the outer diameter of outer rotor component 7, which insures that no contact can occur between stator assembly 23 and magnet array 19, as will be seen below.

It will be apparent to those familiar with the art that magnet array 19 comprises an approximation of a Halbach array, in this instance a sparse Halbach array, which provides an approximately uniform dipole magnetic field 26 within the volume enclosed by the magnet array 19 and which penetrates the stator assembly 23.

Magnet array 19 and stator assembly 23 comprise a type of electrical device that can be used as a motor by energizing conductors contained within the stator assembly 23 in a manner well known in the art to impart a torque about the Z-axis, thereby imparting spin to flywheel rotor assembly 30 and all its affixed components. Similarly, magnet array 19 and stator assembly 23 comprise a type of electrical device that can be used as a generator by connecting an electrical load to conductors contained within the stator assembly 23 under conditions in which surrounding peripheral rotor component 7 is in motion, thereby creating a time-varying magnetic field that penetrates stator assembly 23, inducing electrical current to flow in its conductors. The properties of this motor/generator allow energy to be stored in flywheel rotor assembly 30 by increasing its spin and to be extracted from the flywheel rotor assembly by decreasing its spin, as has long been known in the art of flywheel energy storage. The construction of this motor/generator accommodates eccentric rotation of the flywheel rotor assembly 30, thereby mitigating or eliminating the need for rotor balancing procedures, which is a key aspect of this invention.

This invention contemplates motor/generator configurations other than those incorporating a sparse Halbach array as being operable in their ability to accommodate a flywheel's eccentric rotation, and this invention is not limited thereby.

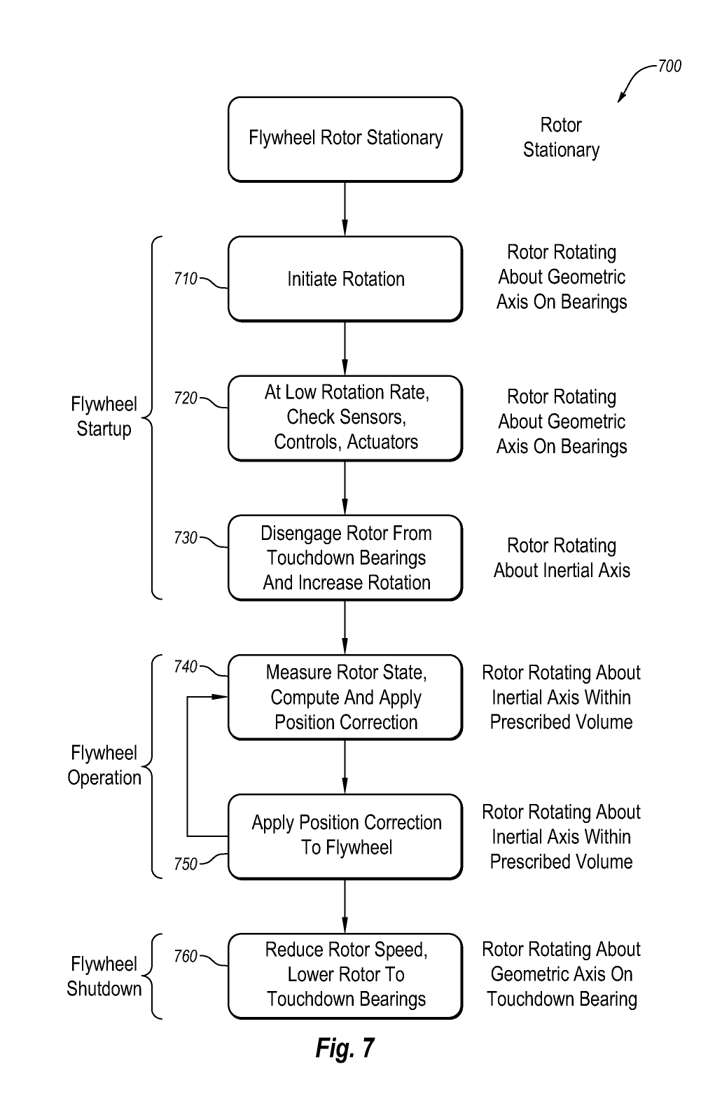

With further regard to FIGS. 4, 5, 6, FIG. 7 is a block diagram illustrating a method 700 of operating a flywheel according to one embodiment of the present invention. At the beginning of method 700 the flywheel rotor assembly 30 is static and resting on touchdown bearing 28. At step 710, the electrical coils in stator 23 are energized to apply torque to the flywheel rotor assembly 30, causing it to initiate rotation. At this point, the flywheel rotor assembly 30 is rotating about its geometric axis 17 on the touchdown bearings 28.

At a predetermined speed compatible with rotation on the touchdown bearing but adequate in magnitude to disclose operational anomalies that would prohibit normal operation, at step 720 optional diagnostic tests are performed on the flywheel rotor and its associated machinery, either by human operators and/or automated control systems.

On passing said optional diagnostic tests at step 720, or after passage of a predetermined period of time, step 730 is performed as additional power is delivered to electrical coils in stator 23 and electromagnet 20c is energized to cause flywheel rotor assembly 30 to move upward to its operating position along the Z-axis, thereby disengaging from touchdown bearing 28 and thereby beginning unconstrained rotation substantially about its inertial rotational axis. At this point, the flywheel startup process is complete and the flywheel moves into the standard flywheel operation process wherein the flywheel rotor assembly 30 is no longer constrained to rotating about its geometric axis 17 and instead is able to rotate about its inertial axis 18.

During unconstrained rotation about the inertial axis 18, sensor means 13 and 15, and position control effectors 22 are employed by computational means to maintain the flywheel rotor assembly 30 within its desired operating volume limits 12. Hence in one embodiment, the sensor means 13, 15, effectors 22 and the means of suspension 10 are all connected to a computer such as the CPU 200. In one embodiment, one CPU 200 is able to control the entire operation of the flywheel rotor assembly 30. As may be understood by one of ordinary skill in the art, this CPU 200 may include any number of components described in more detail below, including but not limited to a processor a memory and the like. Furthermore, more than one CPU 200 may be connected together so as to collectively control the operation of the flywheel rotor assembly 30.

In this embodiment position control effectors 22 any number of effectors known in the art which are capable of interacting with the permanent magnets 21 affixed to the inner rotor component 9 so as to cause the inner rotor component 9 to be moved or repositioned.

Based on the determination made by the CPU 200, during the flywheel operation step of 740, the state of the flywheel rotor assembly 30 is periodically or constantly monitored by a sensor system such as the one described above so that if the flywheel rotor assembly 30 drifts beyond the boundary 12, thereby occluding the passage of light 14 from emitter 13 to photodetector 15, at step 750 the CPU 200 causes a correction of the position of the flywheel rotor assembly 30 to be imposed by position control effectors 22, which moving the flywheel rotor assembly 30 back within its desired operating boundary 11.

On cessation of operation of the flywheel rotor assembly 30 at step 760, and on achieving a rotation rate compatible with lowering the flywheel rotor assembly 30 to rest upon touchdown bearing 28, electromagnet 20c is energized so as to allow the descent of flywheel rotor assembly 30 to engage with and rest upon touchdown bearing 28.

It will be apparent to those skilled in the art that this invention readily encompasses a range of modalities and is not thereby limited.

For example, suspension of the rotor along the Z-axis may be accomplished by a number of means. Although magnetic suspension is described in this embodiment, other means can be employed and magnetic suspension is not a limiting aspect of the invention.

Furthermore, a variety of position sensing technologies is known to the art: these include sensing by means of changes in physical properties including but not limited to capacitance or inductance, and/or changes in dynamic properties including but not limited to eddy currents, and/or direct ranging technologies such as ultrasound (in supporting atmospheres), RADAR and LIDAR, and/or sensors based on parallax and/or image focus optimization, and these are included without limitation within the scope of this invention.

A variety of flywheel position control effector technologies are also known to the art and the specific means for performing position control are not limited to the configurations described herein. Other means of performing position control include magnetic, electromagnetic, and electrostatic forces and combinations thereof; mechanical means such as impinging fluids and other mechanical means of delivering corrective impulses to cause a flywheel rotor to occupy a preferred position, including devices containing rolling elements that engage a flywheel rotor only when the spinning rotor exceeds predetermined spatial limits, and these are included without limitation within the scope of this invention.

The embodiments described herein may include the use of a special purpose or general-purpose computer 200 including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A flywheel rotor assembly comprising:
a rotor assembly having an inner rotor component coupled to an outer rotor component by a mechanical connection, wherein the rotor assembly is configured to rotate about an inertial axis of rotation;
a means for rotating the rotor assembly about its inertial axis;
a means for supporting the rotor assembly while it rotates around its inertial axis without confining the rotor assembly to rotate around a defined geometric axis of rotation of the rotor assembly;
a means for detecting when the rotor assembly rotates outside a first boundary comprising a natural boundary that the rotating assembly rotates in when rotating about its inertial axis first boundary and supported by the means for supporting the rotor assembly; and
a means for performing positional correction on the rotor assembly when it is determined that the rotor assembly rotates outside the first boundary so as to cause the rotor assembly to rotate to rotate inside the first boundary, wherein the positional correction does not confine the rotor assembly to rotate around its defined geometric axis of rotation.

2. The flywheel rotor assembly of claim 1, wherein the means for rotating the rotor assembly comprises an array of magnets disposed around an inner circumference of the inner rotor component which has a hollow interior and an electromagnetic coil assembly housed within the hollow interior of the inner rotor component which is capable of imparting a magnetic field on the array of magnets in order to rotate the rotor assembly.

3. The flywheel rotor assembly of claim 2, wherein the array of magnets is arranged as a sparse Halbach magnet array.

4. The flywheel rotor assembly of claim 1, wherein the a means for rotating the rotor assembly about its inertial axis and the means for supporting the rotor assembly while it rotates around its inertial axis do not contact the rotor assembly while it rotates around its inertial axis.

5. The flywheel rotor assembly of claim 1, wherein the means for supporting the rotating body while it rotates around its inertial axis comprise a levitation magnet assembly.

6. The flywheel rotor assembly of claim 1, wherein the means for detecting when the rotor assembly rotates outside the first boundary comprises a light emitter and a photodetector.

7. The flywheel rotor assembly of claim 1, wherein the means for detecting when the rotor assembly rotates outside the first boundary detects when the rotor assembly rotates outside a predetermined second boundary which is larger than the first boundary.

8. The flywheel rotor assembly of claim 1, wherein the means for performing positional correction on the rotor assembly comprise a plurality of effectors which are capable of selectively interacting with a plurality of magnets affixed to the inner rotor component so as to cause the rotor assembly to be repositioned.

9. The flywheel rotor assembly of claim 1, wherein at least one of the inner rotor component, the outer rotor component, and the mechanical connection is formed of a material selected from the group of materials including metals, plastics, glasses, and ceramics.

10. A flywheel rotor assembly comprising:
a rotor assembly having an inner rotor component coupled to an outer rotor component by a mechanical connection, wherein the rotor assembly is configured to rotate about an inertial axis of rotation;
a means for rotating the rotor assembly;
a first means for supporting the rotor assembly which confines the rotor assembly to rotate around a geometric axis of the rotor assembly;
a means for causing the first means for supporting the rotor assembly to disengage from the rotor assembly;
a second means for supporting the rotor assembly while it rotates about an inertial axis of the rotating assembly without confining the rotor assembly to rotate around a defined geometric axis of rotation of the rotor assembly;
a means for detecting when the rotor assembly rotates outside the first boundary; and
a means for performing positional correction on the rotor assembly when it is determined that the rotor assembly rotates outside the first boundary so as to cause the rotor assembly to rotate to rotate inside the first boundary, wherein the positional correction does not confine the rotor assembly to rotate around its defined geometric axis of rotation.

11. The flywheel rotor assembly of claim 10, wherein the means for rotating the rotor assembly comprises an array of magnets disposed around an inner circumference of the inner rotor component which has a hollow interior and an electromagnetic coil assembly housed within the hollow interior of the inner rotor component which is capable of imparting a magnetic field on the array of magnets in order to rotate the rotor assembly.

12. The flywheel rotor assembly of claim 11, wherein the array of magnets is arranged as a sparse Halbach magnet array.

13. The flywheel rotor assembly of claim 10, wherein the means for rotating the rotor assembly and the means for supporting the rotor assembly while it rotates around its inertial axis do not contact the rotor assembly while it rotates around its inertial axis.

14. The flywheel rotor assembly of claim 10, wherein the second means for supporting the rotating body while it rotates around its inertial axis comprise a levitation magnet assembly.

15. The flywheel rotor assembly of claim 10, wherein the means for detecting when the rotor assembly rotates outside the first boundary comprises a light emitter and a photodetector.

16. The flywheel rotor assembly of claim 10, wherein the means for detecting when the rotor assembly rotates outside the first boundary detects when the rotor assembly rotates outside a predetermined second boundary which is larger than the first boundary.

17. The flywheel rotor assembly of claim 10, wherein the means for performing positional correction on the rotor assembly comprise a plurality of effectors which are capable of selectively interacting with a plurality of magnets affixed to the inner rotor component so as to cause the rotor assembly to be repositioned.

18. The flywheel rotor assembly of claim 10, wherein at least one of the inner rotor component, the outer rotor component, and the mechanical connection is formed of a material selected from the group of materials including metals, plastics, glasses, and ceramics.

19. A method for stabilizing flywheel rotation, the method comprising:
a rotor assembly having an inner rotor component coupled to an outer rotor component by a mechanical connection to rotate about an inertial axis of rotation of the rotor assembly, said rotor assembly having a displacement between its inertial axis of rotation and a defined geometric axis of rotation of the rotor assembly;
supporting the rotor assembly while it rotates around its inertial axis without confining the rotor assembly to rotate around the defined geometric axis of rotation;
detecting when the rotor assembly rotates outside a first boundary comprising a natural boundary that the rotating assembly rotates in when rotating about its inertial axis first boundary and being supported;
performing positional correction on the rotor assembly when it is determined that the rotor assembly rotates outside the first boundary so as to cause the rotor assembly to rotate to rotate inside the first boundary, wherein the positional correction does not confine the rotor assembly to rotate around its defined geometric axis of rotation.

20. The method of claim 19, wherein the rotor assembly is rotated using an array of magnets disposed around an inner circumference of the inner rotor component which has a hollow interior and an electromagnetic coil assembly housed within the hollow interior of the inner rotor component which is capable of imparting a magnetic field on the array of magnets in order to rotate the rotor assembly.

21. The method of claim 20, wherein the array of magnets is arranged as a sparse Halbach magnet array.

22. The method of claim 19, wherein detecting when the rotor assembly rotates outside the first boundary comprises detecting when the rotor assembly rotates outside a predetermined second boundary which is larger than the first boundary.

23. The method of claim 19, wherein at least one of the inner rotor component, the outer rotor component, and the mechanical connection is formed of a material selected from the group of materials including metals, plastics, glasses, and ceramics.
